(19) United States
(12) Patent Application Publication
(10) Pub. No.: US 2009/0178407 A1
(43) Pub. Date: Jul. 16, 2009

(54) ENHANCED ENGINE AIR BREATHING SYSTEM WITH AFTER TREATMENT DEVICE BEFORE THE TURBOCHARGER

(75) Inventors: Volker Joergl, Ortonville, MI (US); Olaf Weber, Bloomfield Hills, MI (US)

Correspondence Address: WARN, HOFFMANN, MILLER & OZGA, P.C., P.O. BOX 70098, ROCHESTER HILLS, MI, 48307, US

(73) Assignee: BorgWarner Inc., Auburn Hills, MI (US)

(21) Appl. No.: 12/306,009

(22) PCT Filed: Jul. 11, 2007
(86) PCT No.: PCT/US2007/015794

§ 371 Date: Dec. 22, 2008

Related U.S. Application Data
(60) Provisional application No. 60/830,048, filed on Jul. 11, 2006.

(51) Int. Cl. F02D 23/00; F01N 5/04; F02M 25/07; F01N 3/035; F01N 3/10; F01N 9/00; F02B 33/00

(52) U.S. Cl. 60/602; 60/280; 123/568.11; 60/297; 60/299; 60/287; 123/564

(57) ABSTRACT

A turbocharger arrangement providing a turbocharger, at least one treatment device, and at least one boost device. The turbocharger has a turbine and a compressor that are moveably coupled to one another. The turbine has an upstream path and a downstream path. The compressor has an upstream path and a downstream path. The at least one treatment device is in fluid communication with the upstream path of the turbine. The at least one additional boost device is operably engaged with the turbocharger to assist the flow of a gaseous fluid through the at least one treatment device and the turbocharger.

### CROSS-REFERENCE TO RELATED APPLICATIONS

This application claims the benefit of U.S. Provisional Application No. 60/830,048, filed Jul. 11, 2006. The disclosure of the above application is incorporated herein by reference.

### FIELD OF THE INVENTION

The present invention relates to an air breathing system in a turbocharger arrangement.

### BACKGROUND OF THE INVENTION

Current and future emissions standards for motorized vehicles in the United States and foreign countries are requiring lower emissions. Typically, engine assemblies designed to minimize emissions use large treatment devices or filters positioned as close to the engine cylinder as possible. This allows for the turbocharger arrangement to treat the engine exhaust as soon as possible after it exits the engine.

Placing the treatment device directly after or downstream of the engine can have negative affects on other components in the vehicle's engine assembly. For example, placing the treatment device between the engine and a turbocharger can cause unwanted transient flow forces in the turbocharger. Thus, the benefits of treating exhaust gas before it passes through the turbine will be achieved only with sacrificing the flow stream to the turbine.

Therefore, it is desirable to develop an air breathing system for use in an engine assembly which allows for the treatment device, such as a filter, to be placed upstream of the turbocharger while counteracting the undesirable effects these treatment devices have on transient flow forces in the turbocharger.

### SUMMARY OF THE INVENTION

A turbocharger arrangement providing a turbocharger, at least one treatment device, and at least one additional boost device. The turbocharger has a turbine and a compressor that are moveably coupled to one another. The turbine has an upstream path and a downstream path. The compressor has an upstream path and a downstream path. The at least one treatment device is in fluid communication with the upstream path of the turbine. The additional at least one boost device is operably engaged with the turbocharger to assist the flow of a gaseous fluid through the at least one treatment device and the turbocharger.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a schematic view of a turbocharger arrangement depicting locations for a boost device (shown in phantom) in accordance with the present invention;

FIG. 2 is a schematic view of the turbocharger arrangement having a high pressure exhaust gas recirculation (EGR) path depicting locations for the boost device in accordance with the present invention;

FIG. 3 is a schematic view of the turbocharger arrangement having a low pressure EGR path depicting locations for the boost device (shown in phantom) in accordance with the present invention; and

FIG. 4 is schematic view of the turbocharger arrangement having the high pressure EGR path (shown in phantom) and the low pressure EGR path (shown in phantom) depicting the locations for the boost device (shown in phantom), where predetermined combinations of the above components can be used in accordance with the present invention.

### DETAILED DESCRIPTION OF THE PREFERRED EMBODIMENTS

The following description of the preferred embodiment(s) is merely exemplary in nature and is in no way intended to limit the invention, its application, or uses.

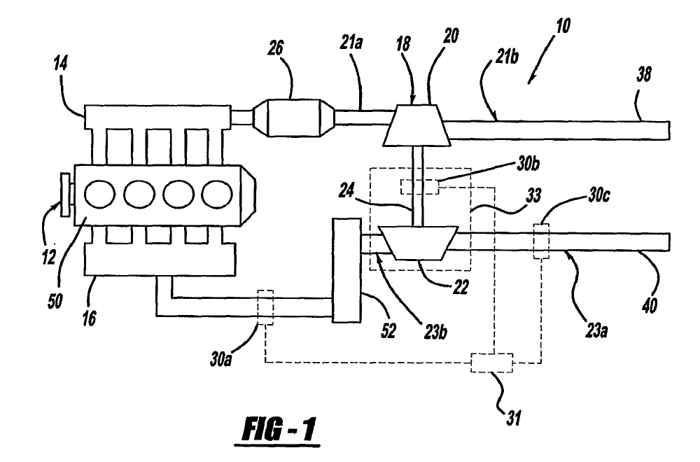

Referring to FIG. 1, a turbocharger arrangement is generally shown at 10. The turbocharger arrangement 10 has an engine generally indicated at 12 that has an exhaust side 14 and an intake side 16. A turbocharger generally indicated at 18 is in fluid communication with the engine 12. The turbocharger 18 has a turbine 20 and a compressor 22 moveably coupled by a shaft 24. Thus, as the turbine 20 rotates, the connection of the turbine 20 and compressor 22 by the shaft 24 causes the compressor 22 to rotate. The turbine 20 has an upstream path generally indicated at 21a and a downstream path generally indicated at 21b. The compressor 22 has an upstream path generally indicated at 23a and a downstream path generally indicated at 23b.

At least one treatment device or filter 26 is in fluid communication with the upstream path 21a. Preferably, the filter 26 is in fluid communication with the exhaust 14 and the turbine 20. Thus, the filter 26, which is typically a treatment device for a gaseous fluid, (e.g., exhaust gas) is located before or on the upstream path 21a of the turbine 20. It is also possible for multiple filters 26 to be used at one or more than one location in the turbocharger arrangement 10 depending on the particular application. The filter 26 cleans the gaseous fluid of undesirable emission chemicals or gases, soot, debris, and the like. An example of the filter 26 is, but not limited to, a diesel oxidation catalyst, a diesel particulate filter, a NOX-storage catalyst, SCR catalyst, or the like. A predetermined number of filters 26 in a combination of types of filters 26 can be in fluid communication between the exhaust 14 and turbine 20.

The arrangement 10 includes a number of boost devices 30a-30c operably engaged with the turbocharger to assist the flow of a gaseous fluid to the intake manifold so that the temperature and/or pressure of the gaseous fluid does not decrease below a predetermined value as a result of passing through the components of the arrangement 10. The boost devices 30a-30c can be located in several locations in the turbocharger arrangement 10. Additionally, it is possible for multiple boost devices to be used at several locations discussed herein. FIG. 1 shows in dashed lines various possible locations of the boost devices 30a-30c.

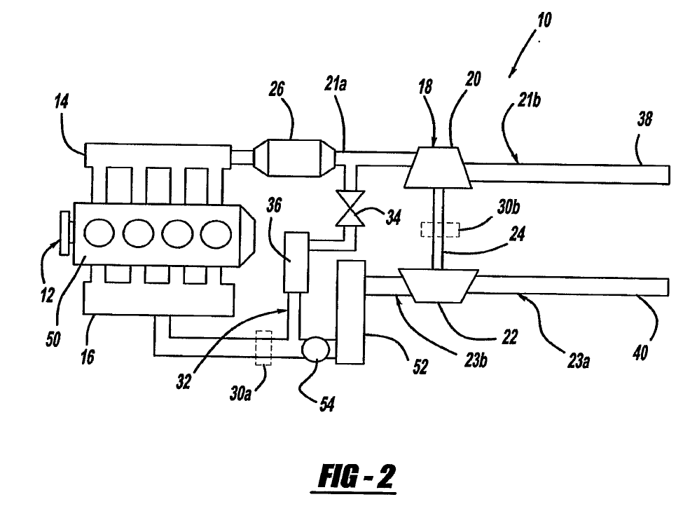

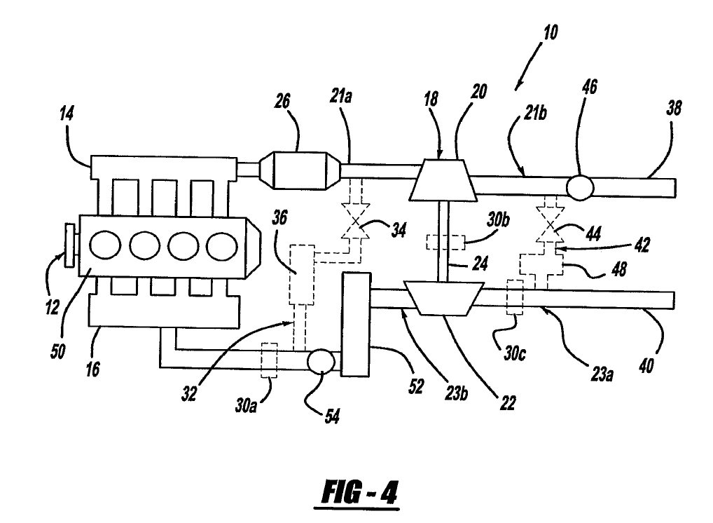

In reference to FIGS. 2 and 4, when the boost device 30a is positioned generally as shown, a high pressure exhaust gas recirculation (EGR) path generally indicated at 32 is in fluid communication between the filter 26 and the intake 14. Typically, the high pressure EGR path 32 has at least a high pressure EGR valve 34 and an EGR cooler 36. The boost device 30a is in fluid communication with the junction of the downstream of the compressor 22 and downstream of the high pressure EGR path 32 and the intake 14. It should be appreciated that the boost device 30 can be upstream of the high pressure EGR path 32.

With continued reference to FIG. 1 another location shows the boost device 30c is in fluid communication with the upstream path 23a. Preferably, the boost device 30c is in fluid communication between the compressor 22 and an intake 40 of the turbocharger arrangement 10.

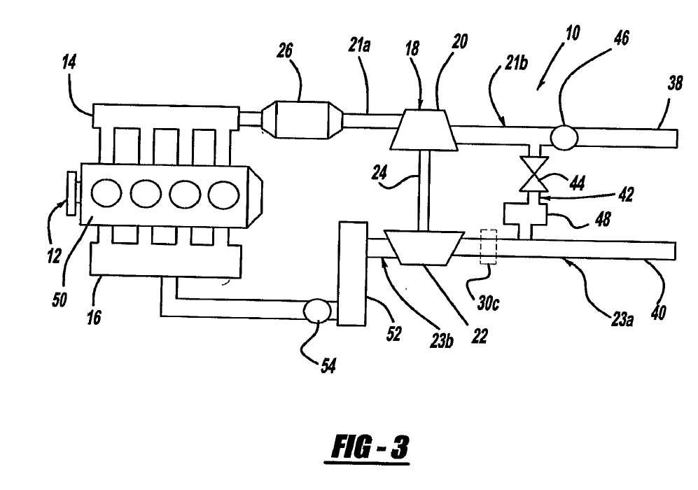

In reference to FIGS. 3 and 4, the boost device 30c is depicted as being used in a low pressure EGR path, generally indicated at 42, in fluid communication with an exhaust of the turbine 20 and an intake of the compressor 22. Typically, the low pressure EGR path 42 has at least a low pressure EGR valve 44, a throttle valve 46, or a suitable combination of the low pressure EGR valve 44, throttle valve 46, and an EGR cooler 48. The boost device 30c is in fluid communication downstream of the low pressure EGR path 42 and the intake 40 and upstream of the compressor 22. It should be appreciated that the boost device 30c can be upstream of the junction of the low pressure EGR path 42.

With continued reference to FIGS. 1-4, in the above embodiments the boost devices 30a-30c can be for example, but not limited to, an electric power source or hydraulic power source driving a secondary compressor, or a mechanical supercharger. The electric or hydraulic power sources typically drive a centrifugal compressor, a hydraulic or pneumatic turbine, a positive displacement compressor, or the like. The mechanical supercharger can be either directly coupled to the engine 12 or indirectly coupled to the engine 12 by a transmission, such as but not limited to, a belt and pulley, a chain and sprocket, a fully variable ratio transmission, or the like.

With reference to FIGS. 1 and 4, another alternate embodiment is shown where the boost device 30b is operably connected to the shaft 24. In this embodiment, the boost device 30b rotates the shaft 24 in addition to rotating the turbine 20. Examples of the boost device 30b are, but not limited to, an electric or pneumatic motor operably connected to the shaft 24, a hydraulic turbine operably connected to the shaft 24, or pneumatic nozzles forcing air onto the compressor 22 blades.

With continued reference to FIGS. 1-4, an alternate embodiment of the turbocharger arrangement 10 has a valve timing system 50 in the engine 12. Thus, any of the above described boost devices 20a-30c configurations can be used with the valve timing system 50 in order to control the operating conditions of the turbocharger arrangement 10. Further, it should be appreciated that any of the boost device 30a-30c configurations can be used with any predetermined combination of the high pressure EGR path 32 and low pressure EGR path 42. In addition, multiple boost devices 30a-30c can be used in any predetermined combination of number of boost devices 30a-30c and locations.

In operation, the gaseous fluid exits the engine 12 at the exhaust 14 and passes through the filter 26. The gaseous fluid then passes through either the turbine 20 or the high pressure EGR path 32 (if in use). The gaseous fluid that passes through the turbine 20 either exits the turbocharger arrangement 10 through the exhaust 38 or passes through the low pressure EGR path 42 (if in use).

The gaseous fluid that passes through the low pressure EGR path 42 or high pressure EGR path 32, mixes with fresh air from the intake 40 of the turbocharger arrangement 10. If the high pressure EGR path 32 or low pressure EGR path 42 are not in use, then the gaseous fluid and fresh air mixture used to describe the operation below consists of only fresh air. The mixture of gaseous fluid, if the low pressure EGR path 42 is used, and fresh air then passes through the compressor 22, which is rotating since the compressor 22 is moveably coupled to the turbine 20 by the shaft 24. The mixture of gaseous fluid and fresh air pass through a charge air cooler 52, which is in fluid communication with an exhaust of the compressor 22, in order to reduce the temperature of the gaseous fluid and fresh air mixture. A throttle valve 54 is in fluid communication with an exhaust of the charge air cooler 52 in order to control the amount of flow of gaseous fluid onto the intake side 16. After the throttle valve 54, gaseous fluid from the high pressure EGR path 32, if in use, will mix with the gaseous fluid and fresh air mixture from the charge air cooler 52 and then enter the intake 16 of the engine 12.

Having the boost devices 30a-30c enhances the flow through the turbocharger arrangement 10 and allow for the use of larger filters 26 because the boost devices 30a-30c compensate for any flow loss that would occur as a result of using a larger filter. The end result is that using a larger filter will provide better emission reduction characteristics without sacrificing the performance of the turbocharger arrangement 10.

Further, due to the lack of temperature and/or pressure drops in the gaseous fluid through the filter 26, the turbocharger 18 is not required to be adjacent to the engine 12. Thus, the packaging of the turbocharger arrangement 10 is very flexible. Also, the gaseous fluid passes through the filter 26 upstream of the turbocharger 18 is at a higher temperature than if the filter 26 was downstream of the turbocharger 18, which allows for the catalytic conversions in the filter to occur at a quicker rate and more consistently which enhances the efficiency of the filter 26 and the turbocharger arrangement 10. This also allows for the materials used in the filter 26 to be reduced which reduces the cost of the filter 26.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A turbocharger arrangement comprising:
a turbocharger having a turbine and a compressor moveably coupled to one another, wherein said turbine has an upstream path and a downstream path and said compressor has an upstream path and a downstream path;
at least one treatment device in fluid communication with said upstream path of said turbine; and
at least one boost device operably engaged with said turbocharger to assist flow of a gaseous fluid through said at least one treatment device and said turbocharger.

2. The turbocharger arrangement of claim 1, wherein said at least one boost device is in fluid communication between said compressor and an intake of said turbocharger arrangement.

3. The turbocharger arrangement of claim 1, wherein said at least one boost device is in fluid communication with said downstream path of said compressor.

4. The turbocharger arrangement of claim 1, wherein said at least one boost device is connected to said turbocharger.

5. The turbocharger arrangement of claim 4, wherein said at least one boost device is at least one of an electric motor, a pneumatic motor, a hydraulic turbine operably connected to said turbocharger.

6. The turbocharger arrangement of claim 1 further comprising a high pressure exhaust gas recirculation path in fluid communication between said upstream path of said turbine and said downstream path of said compressor.

7. The turbocharger arrangement of claim 6, wherein said at least one boost device is in fluid communication between said high pressure EGR path and said downstream path of said compressor.

8. The turbocharger arrangement of claim 1 further comprising a low pressure EGR path in fluid communication between a downstream path of said turbine and an upstream path of said compressor.

9. The turbocharger arrangement of claim 8, wherein said at least one boost device is in fluid communication between said low pressure EGR path and said compressor.

10. The turbocharger arrangement of claim 1, wherein said at least one boost device is at least one of an electric power source driving a secondary compressor, a hydraulic power source driving said secondary compressor, at least one pneumatic nozzle forcing air onto at least one blade of said compressor, and a mechanical supercharger.

11. The turbocharger arrangement of claim 10, wherein said mechanical supercharger is operably coupled to an engine.

12. The turbocharger arrangement of claim 1, wherein said exhaust after treatment device is at least one of a diesel oxidation catalyst, a diesel particulate filter, an NOX-storage catalyst or a SCR catalyst.

13. An turbocharger arrangement comprising:
a turbocharger having a turbine and a compressor moveably coupled to one another, wherein said turbine has an upstream path and a downstream path and said compressor has an upstream path and a downstream path;
at least one treatment device in fluid communication with said upstream path of said turbine; and
at least one boost device in fluid communication with at least one of said upstream path of said compressor or said downstream path of said compressor, wherein said at least one boost device increases the flow of a gaseous fluid through said at least one treatment device and counter-acts transient flow forces in said turbocharger.

14. The turbocharger arrangement of claim 13 further comprising a high pressure exhaust gas recirculation (EGR) path in fluid communication between said upstream path of said turbine and said downstream path of said compressor.

15. The turbocharger arrangement of claim 14, wherein said boost device is in fluid communication between said high pressure EGR path and said downstream path of said compressor.

16. The turbocharger arrangement of claim 13 further comprising a low pressure EGR path in fluid communication between an exhaust of said turbine and an intake of said compressor.

17. The turbocharger arrangement of claim 16, wherein said boost device is in fluid communication between said low pressure EGR path and said compressor.

18. The turbocharger arrangement of claim 13, wherein said at least one boost device is at least one of an electric power source driving a secondary compressor, a hydraulic power source driving said secondary compressor, at least one pneumatic nozzle forcing air onto at least one blade of said compressor, and a mechanical supercharger.

19. A turbocharger arrangement comprising:
a turbocharger having a turbine and a compressor moveably coupled to one another, wherein said turbine has an upstream path and a downstream path, and said compressor has an upstream path and a downstream path;
at least one treatment device in fluid communication with said upstream path of said turbine;
a high pressure exhaust gas recirculation path in fluid communication between said at least one treatment device and said downstream path of said compressor;
a low pressure exhaust gas recirculation path connected between said downstream path of said turbine and an intake of said upstream path of said compressor; and
one or more boost devices between said low pressure exhaust gas recirculation path and said engine.

20. The turbocharger arrangement of claim 19, wherein said low pressure exhaust gas recirculation path further comprises a low pressure exhaust gas recirculation valve for controlling the flow through the low pressure exhaust gas recirculation path.

21. The turbocharger arrangement of claim 19, wherein said one or more boost devices is at least one of an electric power source driving a secondary compressor, a hydraulic power source driving said secondary compressor, at least one pneumatic nozzle forcing air onto at least one blade of said compressor, and a mechanical supercharger.
